(19) United States
(12) Patent Application Publication
(10) Pub. No.: US 2007/0139847 A1
(43) Pub. Date: Jun. 21, 2007

(54) Power tool with circuit protection capability

(75) Inventor: Chang-Shin Liu, Chia Yi City (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Aebos Technology Co., Ltd., Shuishang Hsiang (TW)

(21) Appl. No.: 11/603,421

(22) Filed: Nov. 21, 2006

(30) Foreign Application Priority Data
Dec. 15, 2005 (TW) 094221880

(51) Int. Cl. H01H 73/00

(52) U.S. Cl. 361/115

(57) ABSTRACT

A power tool includes a battery-operated power supplying unit adapted to be connected to a battery unit and to generate battery status information, a driving unit adapted to be coupled to a tool bit, a protection unit for making and breaking an electrical circuit between the power supplying unit and the driving unit, a user-actuated unit for enabling operation of the protection unit to make the electrical circuit, and a control unit for enabling operation of the protection unit to break the electrical circuit when the control unit detects an abnormal condition from the battery status information.

### CROSS-REFERENCE TO RELATED APPLICATION

This application claims priority of Taiwanese application no. 094221880, filed on Dec. 15, 2005.

### BACKGROUND OF THE INVENTION

1. Field of the Invention

The invention relates to a power tool, more particularly to a power tool for driving a tool bit.

2. Description of the Related Art

A conventional rechargeable power tool uses a rechargeable battery unit for supplying power to an electric motor that drives rotation of a tool bit, such as a screw driving bit, a drill bit, etc. In the event of an excessive load, and the motor is unable to drive rotation of the tool bit, high electric current can result in damage to motor coils, and consumption of battery power is undesirably accelerated.

### SUMMARY OF THE INVENTION

Therefore, the object of the present invention is to provide a power tool capable of terminating supply of battery power in the event of an overload to prevent damage to circuit components of the power tool.

Accordingly, a power tool of this invention comprises a battery-operated power supplying unit, a driving unit, a protection unit, a user-actuated unit, and a control unit.

The power supplying unit is adapted to be connected to a battery unit and to generate battery status information.

The driving unit is adapted to be coupled to a tool bit.

The protection unit is connected electrically to the power supplying unit and the driving unit, and is operable in one of a circuit-making state for making an electrical circuit between the power supplying unit and the driving unit to enable drive operation of the driving unit, and a circuit-breaking state for breaking the electrical circuit between the power supplying unit and the driving unit to disable the drive operation of the driving unit.

The user-actuated unit is connected electrically to the protection unit, and is manually operable so as to switch operation of the protection unit from the circuit-breaking state to the circuit-making state.

The control unit is connected electrically to the power supplying unit and the protection unit, and is operable so as to switch operation of the protection unit from the circuit-making state to the circuit-breaking state when the control unit detects one of an insufficient battery voltage condition and an overload condition from the battery status information.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a power tool according to the present invention;

FIG. 2 is a schematic side view of the preferred embodiment;

FIG. 3 is a schematic circuit block diagram of the preferred embodiment; and

FIG. 4 is a schematic electrical circuit diagram of the preferred embodiment.

### DETAILED DESCRIPTION OF THE PREFERRED EMBODIMENT

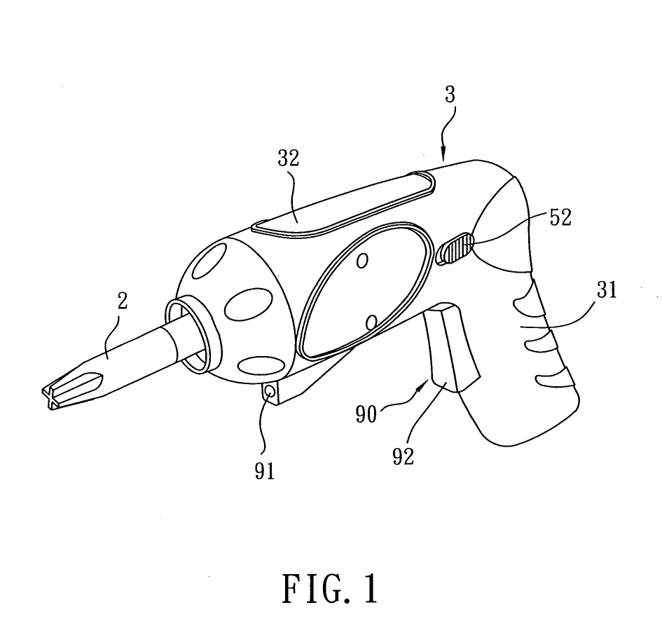

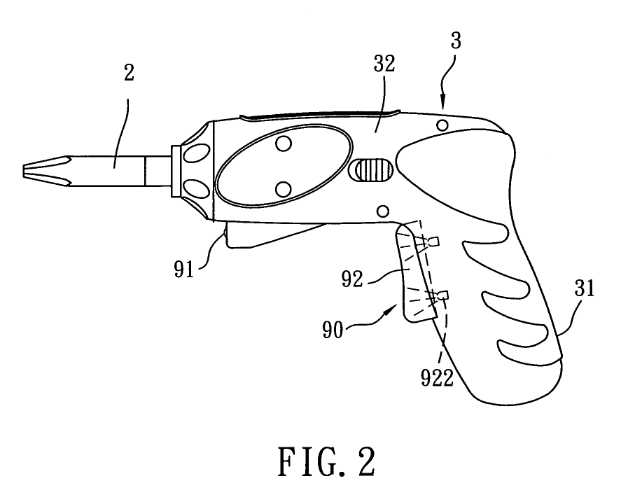

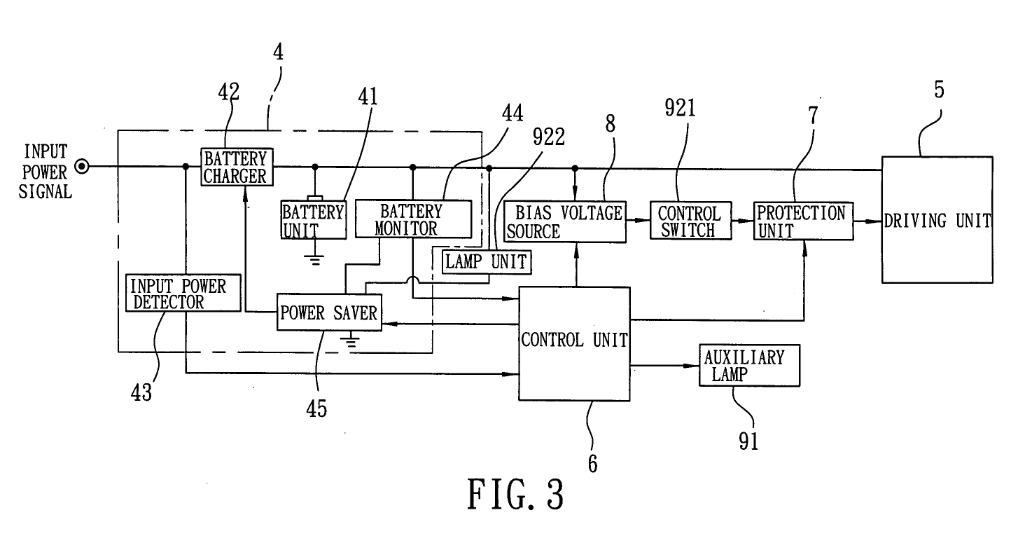

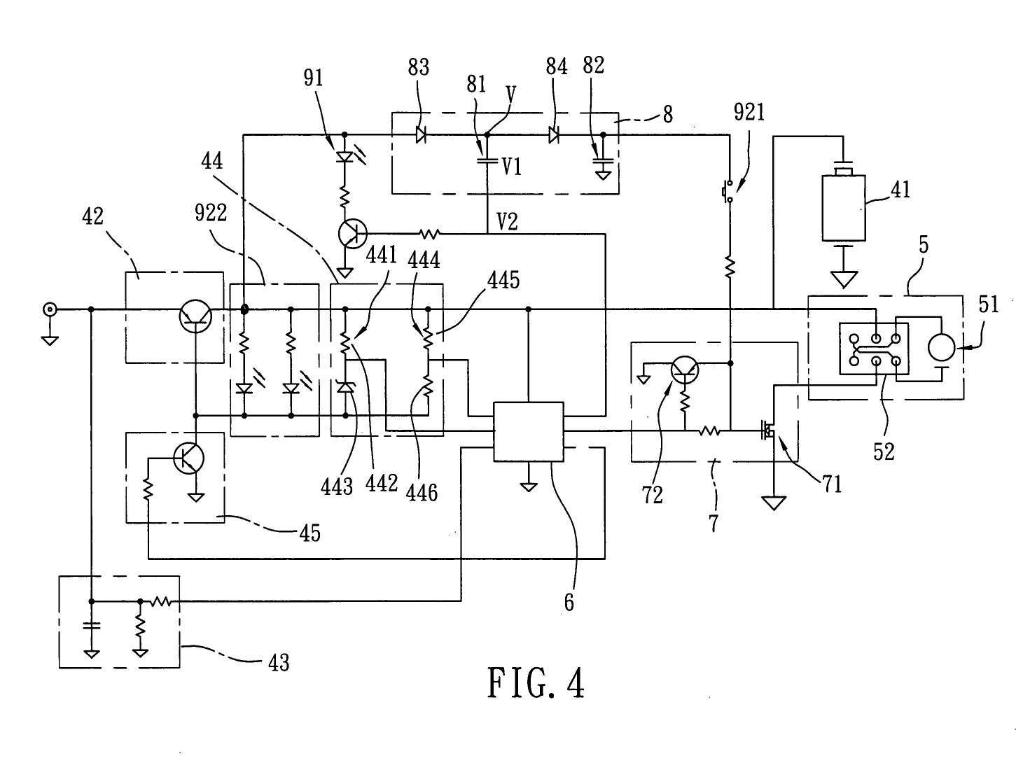

Referring to FIGS. 1 to 4, the preferred embodiment of a power tool according to the present invention is adapted for driving a tool bit 2, and includes a housing 3, a battery-operated power supplying unit 4, a driving unit 5, a control unit 6, a protection unit 7, a bias voltage source 8, an auxiliary lamp 91, and a user-actuated unit 90.

The housing 3 is generally L-shaped, and includes a vertically extending handle portion 31 and a barrel portion 32 that extends forwardly from a top end of the handle portion 31 for receiving the driving unit 5 therein and that is mounted with the auxiliary lamp 91. In this embodiment, the housing 3 is in the form of a gun-shaped housing. However, in practice, the housing 3 may be in the form of a straight tube or other shapes suitable for gripping.

The power supplying unit 4 is mounted in the housing 3, is adapted to be connected to a battery unit 41 that is contained in the housing 3, and includes a battery charger 42, an input power detector 43, a battery monitor 44, and a power saver 45. The battery charger 42 is adapted to connected electrically to an external power source and the battery unit 41, and is operable so as to recharge the battery unit 41. The input power detector 43 is adapted for detecting supply of an input power signal to the battery charger 42. The battery monitor 44 is adapted to be connected electrically to the battery unit 41, and is operable so as to generate battery status information. The power saver 45 is connected electrically to the battery charger 42 and the battery monitor 44. In this embodiment, the battery unit 41 includes a lithium battery.

In this embodiment, the battery monitor 44 includes a reference voltage loop 441 and a battery voltage loop 444 connected in parallel and adapted to be connected to the battery unit 41. The reference voltage loop 441 includes a resistor 442 and a Zener diode 443 connected in series, and is connected to the control unit 6 at a junction of the resistor 442 and the Zener diode 443 for providing a reference voltage level to the control unit 6. The battery voltage loop 444 includes a pair of resistors 445, 446 connected in series, and is connected to the control unit 6 at a junction of the resistors 445, 446 for providing a battery voltage fraction to the control unit 6. The reference voltage level and the battery voltage fraction serve as the battery status information that is provided to the control unit 6.

The driving unit 5 is mounted in the barrel portion 32 of the housing 3, is adapted to be coupled to the tool bit 2, and is coupled electrically to the power supplying unit 4. The driving unit 5 includes a motor 51 for driving the tool bit 2, and a direction control switch 52 in series connection between the motor 51 and the battery unit 41. The direction control switch 52 is accessible externally of the housing 52, and is operable to change polarity connections of the motor 51 to thereby change direction of rotation of the tool bit 2. Since the feature of this invention does not reside in the specific construction of the driving unit 5, further details of the same will be omitted herein for the sake of brevity.

The protection unit 7 is mounted in the housing 3, is connected electrically to the power supplying unit 4 and the driving unit 5, and is operable in one of a circuit-making state for making an electrical circuit between the power supplying unit 4 and the driving unit 5 to enable drive operation of the driving unit 5, and a circuit-breaking state for breaking the electrical circuit between the power supplying unit 4 and the driving unit 5 to disable the drive operation of the driving unit 5. In this embodiment, the protection unit 7 includes a field effect transistor 71 and a bipolar junction transistor 72. The field effect transistor 71 has a gate connected electrically to the user-actuated unit 90 and the control unit 6, a drain connected electrically to the switch 52 of the driving unit 5, and a grounded source. The bipolar junction transistor 72 has an emitter connected electrically to the gate of the field effect transistor 71, a gate connected electrically to the control unit 6, and a grounded collector.

The bias voltage source 8 includes a first capacitor 81 connected to the battery charger 42 via a first diode 83 and further connected to the control unit 6, and a second capacitor 82 connected to the first capacitor 81 via a second diode 84. The bias voltage source 8 has a bias voltage (V) with a first voltage component (VI) across the first capacitor 81 and a second voltage component (V2) from the control unit 6. The first voltage component (V1) is stored in the first capacitor 81 when recharging the battery unit 41. By setting the second voltage component (V2) to be equal to an actual battery voltage of the battery unit 41, the bias voltage (V) is ensured to be larger than the actual battery voltage of the battery unit 41.

The user-actuated unit includes a button 92 mounted operably to the housing 3 and made of a transparent material, a control switch 921 coupled electrically between the second capacitor 82 of the bias voltage source 8 and the gate of the field effect transistor 71 of the protection unit 7 and operably associated with the button 92, and a lamp unit 922 mounted in the button 92 and coupled electrically between the power saver 45 and the battery unit 41. Through manual operation of the button 92, the control switch 921 of the user-actuated unit 90 is enabled to connect the bias voltage source 8 to the protection unit 7 to thereby switch operation of the protection unit 7 from the circuit-breaking state to the circuit-making state.

The control unit 6, which is implemented using a single-chip microprocessor in this embodiment, is mounted in the housing 3, is connected electrically to the power supplying unit 4 and the protection unit 7, and is operable so as to switch operation of the protection unit 7 from the circuit-making state to the circuit-breaking state when the control unit 6 detects one of an insufficient battery voltage condition and an overload condition from the battery status information, i.e., the reference voltage level and the battery voltage fraction, generated by the battery monitor 44 of the power supplying unit 4.

To use the power tool, the button 92 of the user-actuated unit 90 is operated, thereby closing the control switch 921. The control unit 6 is thus enabled to provide the second voltage component (V2) of the bias voltage (V) for activating the auxiliary lamp 91, and the bias voltage (V) is supplied to the field effect transistor 71 of the protection unit 7 through the second diode 84 and the second capacitor 82 of the bias voltage source 8 and the control switch 921 of the user-actuated unit 90.

In the following illustrative example, the rated voltage of the battery unit 41 is 3.6 V, and the operating voltage of the battery unit 41 ranges from 2.7 to 4.2 V. The field effect transistor 71 requires a gate voltage ranging from 3.5 to 5 V for conduction. When the power tool is in use, the actual battery voltage of the battery unit 41 may drop to from 2.7 to 3.5 V. However, since the bias voltage (V) of the bias voltage source 8 includes the first voltage component (V1) across the first capacitor 81 and the second voltage component (V2) from the control unit 6 (the second voltage component being set to be equal to the actual battery voltage of the battery unit 41), the proper gate voltage for conduction can be supplied to the field effect transistor 71 when the control switch 921 is closed upon operation of the button 92 of the user-actuated unit 90. Therefore, drive operation of the driving unit 5 is ensured unless either of the insufficient battery voltage condition or the overload condition is detected by the control unit 6, thereby enhancing battery utilization.

Upon detection by the control unit 6 that the battery voltage fraction has become lower than the reference voltage level, the control unit 6 determines that the actual battery voltage of the battery unit 41 is insufficient, and enables the bipolar junction transistor 72 to conduct so as to ground the gate of the field effect transistor 71, thereby breaking the electrical circuit between the power supplying unit 4 and the driving unit 5 to disable the drive operation of the driving unit 5.

Thereafter, when the power tool is in an idle state, the control unit 6 deactivates the power saver 45 to disable operation of the battery charger 42 and the battery monitor 44, thereby conserving battery power.

In case the actual battery voltage is insufficient, and the battery charger 42 is connected to an external power source, the control unit 6 becomes aware of the supply of the input power signal through the input power detector 43, and responds by activating the power saver 45 to enable operation of the battery charger 42 and the battery monitor 44. The control unit 6 enables recharging of the battery unit 41 through the power saver 45 until the battery voltage fraction becomes equal to the reference voltage level.

Moreover, when the power tool is in use, the control unit 6 continuously monitors and compares the battery voltage fraction with the reference voltage level. If the battery voltage fraction is reduced by an amount corresponding to a predetermined threshold within a predetermined time interval (for instance, 1 to 2 seconds), the control unit 6 determines the presence of an overload condition (e.g., jamming of the driving unit 5 has occurred), and causes the protection unit 7 to break the electrical circuit between the power supplying unit 4 and the driving unit 5 to disable the drive operation of the driving unit 5, thereby preventing damage to the motor 51 of the driving unit 5 due to large electric currents. The control unit 6 permits restoration of the protection unit 7 to the circuit-making state 1 to 2 seconds after the button 92 of the user-actuated unit 90 is released.

In other embodiments of this invention, the control unit 6 may be configured to control the lamp unit 922 to generate a flashing light output for visually indicating the status of the battery unit 41 through the button 92 of the user-actuated unit 90.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A power tool comprising:
a battery-operated power supplying unit adapted to be connected to a battery unit and to generate battery status information;
a driving unit adapted to be coupled to a tool bit;
a protection unit connected electrically to said power supplying unit and said driving unit, and operable in one of a circuit-making state for making an electrical circuit between said power supplying unit and said driving unit to enable drive operation of said driving unit, and a circuit-breaking state for breaking the electrical circuit between said power supplying unit and said driving unit to disable the drive operation of said driving unit;
a user-actuated unit connected electrically to said protection unit and manually operable so as to switch operation of said protection unit from the circuit-breaking state to the circuit-making state; and
a control unit connected electrically to said power supplying unit and said protection unit, and operable so as to switch operation of said protection unit from the circuit-making state to the circuit-breaking state when said control unit detects one of an insufficient battery voltage condition and an overload condition from the battery status information.

2. The power tool as claimed in claim 1, wherein said protection unit includes a transistor coupled to said control unit and selectively operable in one of the circuit-making and circuit-breaking states.

3. The power tool as claimed in claim 1, further comprising a bias voltage source connected electrically to said user-actuated unit, said user-actuated unit being manually operable so as to control electrical connection between said bias voltage source and said protection unit to thereby switch operation of the protection unit between the circuit-making and circuit-breaking states.

4. The power tool as claimed in claim 3, wherein said protection unit includes a field effect transistor having a gate connected electrically to said user-actuated unit and said control unit, a drain connected electrically to said driving unit, and a grounded source.

5. The power tool as claimed in claim 4, wherein said power supplying unit includes a battery charger adapted to be connected to the battery unit and operable so as to recharge the battery unit.

6. The power tool as claimed in claim 5, wherein said bias voltage source includes a capacitor connected to said battery charger and further connected to said control unit,
said bias voltage source having a bias voltage with a first voltage component across said capacitor and a second voltage component from said control unit,
the first voltage component being stored in said capacitor when recharging the battery unit,
the bias voltage being larger than a battery voltage of the battery unit.

7. The power tool as claimed in claim 1, wherein said power supplying unit includes a battery charger adapted to be connected to the battery unit, and operable so as to recharge the battery unit.

8. The power tool as claimed in claim 7, wherein said power supplying unit further includes:
an input power detector connected electrically to said control unit and adapted for detecting supply of an input power signal to said battery charger; and
a battery monitor adapted to be connected to the battery unit, connected electrically to said control unit, and operable so as to generate the battery status information.

9. The power tool as claimed in claim 8, wherein said power supplying unit further includes a power saver connected electrically to said battery charger, said battery monitor and said control unit,
said control unit being operable so as to deactivate said power saver to disable operation of said battery charger and said battery monitor.

10. The power tool as claimed in claim 9, wherein said battery monitor includes a reference voltage loop and a battery voltage loop connected in parallel and adapted to be connected to the battery unit,
said reference voltage loop including a resistor and a Zener diode connected in series, said reference voltage loop being connected to said control unit at a junction of said resistor and said Zener diode for providing a reference voltage level to said control unit,
said battery voltage loop including a pair of resistors connected in series, said battery voltage loop being connected to said control unit at a junction of said resistors of said battery voltage loop for providing a battery voltage fraction to said control unit,
the reference voltage level and the battery voltage fraction serving as the battery status information.

11. The power tool as claimed in claim 1, further comprising a handheld housing having said power supplying unit, said driving unit, said protection unit, and said control unit mounted therein,
said user-actuated unit including a button mounted operably to said housing.
